(19) United States
(12) Patent Application Publication
(10) Pub. No.: US 2018/0207866 A1
(43) Pub. Date: Jul. 26, 2018

(54) ADDITIVE MANUFACTURING SYSTEM HAVING IN-SITU REINFORCEMENT FABRICATION

(71) Applicant: CC3D LLC, Coeur d'Alene, ID (US)

(72) Inventors: Kenneth Lyle Tyler, Coeur d'Alene, ID (US); Ryan C. Stockett, Lebanon, NH (US)

(73) Assignee: CC3D LLC, Coeur d'Alene, ID (US)

(21) Appl. No.: 15/876,278

(22) Filed: Jan. 22, 2018

Related U.S. Application Data
(60) Provisional application No. 62/611,922, filed on Dec. 29, 2017.
(60) Provisional application No. 62/449,899, filed on Jan. 24, 2017.

(51) Int. Cl. B29C 64/165; B29C 64/209; B33Y 10/00; B33Y 30/00; B29C 64/188; B33Y 70/00

(52) U.S. Cl. CPC B29C 64/165; B29C 64/209; B33Y 70/00; B33Y 30/00; B29C 64/188; B33Y 10/00

(57) ABSTRACT

A system for additively manufacturing a composite part is disclosed. The system may include a support moveable in multiple dimensions, and a print head connected to an end of the support. The print head may have a first matrix reservoir configured to wet a continuous strand reinforcement, a first nozzle fluidly connected to the first matrix reservoir, and a first cure enhancer located to expose the continuous strand reinforcement to cure energy upon discharge from the nozzle. The system may also include an in-situ fiber-making apparatus configured to supply the continuous strand reinforcement to the matrix reservoir of the print head.

### RELATED APPLICATIONS

This application is based on and claims the benefit of priority from U.S. Provisional Application Nos. 62/449,899 and 62/611,922 that were filed on Jan. 24, 2017 and Dec. 29, 2017, respectively, the contents of all of which are expressly incorporated herein by reference.

### TECHNICAL FIELD

The present disclosure relates generally to a manufacturing system and, more particularly, to a system having in-situ fabrication of reinforcements used in composite additive manufacturing.

### BACKGROUND

CF3D™ is a known additive manufacturing process, which involves the use of continuous fibers embedded within a matrix material discharging from a moveable print head. The matrix material can be a traditional thermoplastic, a powdered metal, a liquid resin (e.g., a UV curable and/or two-part resin), or a combination of any of these and other known matrixes. Upon exiting the print head, a cure enhancer (e.g., a UV light, an ultrasonic emitter, a heat source, a catalyst supply, etc.) is activated to initiate and/or complete curing of the matrix. This curing occurs almost immediately, allowing for unsupported structures to be fabricated in free space. And when fibers, particularly continuous fibers, are embedded within the structure, a strength of the structure may be multiplied beyond the matrix-dependent strength. An example of this technology is disclosed in U.S. Pat. No. 9,511,543 that issued to Tyler on Dec. 6, 2016 (“the '543 patent”).

Although CF3D™ can produce complex parts that are light-weight and strong, it may be difficult and expensive to provide prefabricated fibers to the print head under all conditions. For example, in mobile applications, where the print head travels a significant distance during material discharge (e.g., during pipeline fabrication), the fibers being supplied to the print head must travel with the print head. This travel requirement may limit an amount of the fibers that can be made available to the print head. Prefabricated fibers may also be expensive to purchase, regardless of whether the print head travels long distances. In addition, there may be a limited selection and/or configuration of fibers available as a prefabricated commodity.

The disclosed system is directed at addressing one or more of the problems set forth above and/or other problems of the prior art.

### SUMMARY

In one aspect, the present disclosure is directed to an additive manufacturing system. The additive manufacturing system may include a support moveable in multiple dimensions, and a print head connected to an end of the support. The print head may have a first matrix reservoir configured to wet a continuous strand reinforcement, a first nozzle fluidly connected to the first matrix reservoir, and a first cure enhancer located to expose the continuous strand reinforcement to cure energy upon discharge from the nozzle. The system may also include an in-situ fiber-making apparatus configured to supply the continuous strand reinforcement to the matrix reservoir of the print head.

In another aspect, the present disclosure is directed to a method of additively manufacturing a composite structure. The method may include fabricating a continuous strand reinforcement, and wetting the continuous strand reinforcement with a matrix as the continuous strand reinforcement is fabricated. The method may also include discharging the matrix-wetted continuous strand reinforcement through a nozzle, exposing the matrix wetting the continuous strand reinforcement to cure energy upon discharge from the nozzle, and moving the nozzle in multiple dimensions during discharge.

### BRIEF DESCRIPTION OF THE DRAWINGS

FIG. 1 is a diagrammatic illustration of an exemplary disclosed additive manufacturing system;

FIGS. 2 and 3 are diagrammatic illustrations of an exemplary disclosed print head that may be used in conjunction with the additive manufacturing system of FIG. 1; and

FIG. 4 is a diagrammatic illustration of an exemplary disclosed external supply system for the additive manufacturing system of FIG. 1.

### DETAILED DESCRIPTION

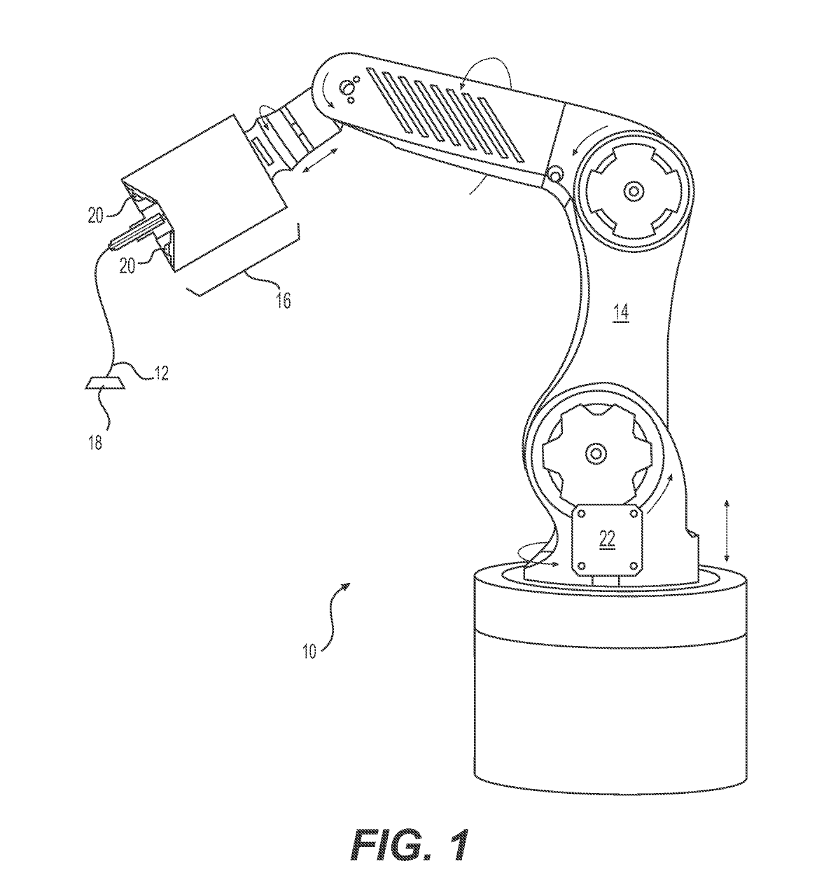

FIG. 1 illustrates an exemplary system 10, which may be used to continuously manufacture a composite structure 12 having any desired cross-sectional shape (e.g., circular, polygonal, etc.). System 10 may include at least a support 14 and a print head (“head”) 16. Head 16 may be coupled to and moved by support 14. In the disclosed embodiment of FIG. 1, support 14 is a robotic arm capable of moving head 16 in multiple directions during fabrication of structure 12, such that a resulting longitudinal axis of structure 12 is three-dimensional. It is contemplated, however, that support 14 could alternatively be an overhead gantry or a hybrid gantry/arm also capable of moving head 16 in multiple directions during fabrication of structure 12. In some embodiments, a drive may mechanically couple head 16 to support 14, and may include components that cooperate to move and/or supply power or materials to head 16.

Head 16 may be configured to receive or otherwise contain a matrix material (“matrix”). The matrix may include any type of material (e.g., a liquid resin, such as a zero-volatile organic compound resin; a powdered metal; etc.) that is curable. Exemplary matrixes include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized, for example by an external device (e.g., an extruder or another type of pump—not shown) that is fluidly connected to head 16 via a corresponding conduit (not shown). In another embodiment, however, the matrix pressure may be generated completely inside of head 16 by a similar type of device. In yet other embodiments, the matrix may be gravity-fed through and/or mixed within head 16. In some instances, the matrix inside head 16 may need to be kept cool and/or dark to inhibit premature curing; while in other instances, the matrix may need to be kept warm for the same reason. In either situation, head 16 may be specially configured (e.g., insulated, chilled, and/or warmed) to provide for these needs.

The matrix may be used to coat, encase, or otherwise at least partially surround any number of continuous reinforcements (e.g., separate fibers, tows, rovings, ribbons, and/or sheets of material) and, together with the reinforcements, make up at least a portion (e.g., a wall) of composite structure 12. The reinforcements may be stored within (e.g., on separate internal spools—not shown) or otherwise passed through head 16 (e.g., fed from external spools). When multiple reinforcements are simultaneously used, the reinforcements may be of the same type and have the same diameter and cross-sectional shape (e.g., circular, square, flat, etc.), or of a different type with different diameters and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous materials that can be at least partially encased in the matrix discharging from head 16.

The reinforcements may be exposed to (e.g., coated with) the matrix while the reinforcements are inside head 16, while the reinforcements are being passed to head 16 (e.g., as a prepreg material), and/or while the reinforcements are discharging from head 16, as desired. The matrix, dry reinforcements, and/or reinforcements that are already exposed to the matrix (e.g., wetted reinforcements) may be transported into head 16 in any manner apparent to one skilled in the art.

The matrix and reinforcement may be discharged from head 16 via at least two different modes of operation. In a first mode of operation, the matrix and reinforcement are extruded (e.g., pushed under pressure and/or mechanical force) from head 16, as head 16 is moved by support 14 to create the 3-dimensional shape of structure 12. In a second mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is being pulled from head 16, the resulting tension in the reinforcement may increase a strength of structure 12, while also allowing for a greater length of unsupported material to have a straighter trajectory (i.e., the tension may act against the force of gravity to provide free-standing support for structure 12).

The reinforcement may be pulled from head 16 as a result of head 16 moving away from an anchor point 18. In particular, at the start of structure-formation, a length of matrix-impregnated reinforcement may be pulled and/or pushed from head 16, deposited onto anchor point 18, and cured, such that the discharged material adheres to anchor point 18. Thereafter, head 16 may be moved away from anchor point 18, and the relative movement may cause the reinforcement to be pulled from head 16. It should be noted that the movement of the reinforcement through head 16 could be assisted (e.g., via internal feed mechanisms), if desired. However, the discharge rate of the reinforcement from head 16 may primarily be the result of relative movement between head 16 and anchor point 18, such that tension is created within the reinforcement. It is contemplated that anchor point 18 could be moved away from head 16 instead of or in addition to head 16 being moved away from anchor point 18.

One or more cure enhancers (e.g., one or more light sources, an ultrasonic emitter, a laser, a heater, a catalyst dispenser, a microwave generator, etc.) 20 may be mounted proximate (e.g., on and/or trailing from) head 16 and configured to enhance a cure rate and/or quality of the matrix as it is discharged from head 16. Cure enhancer 20 may be controlled to selectively expose internal and/or external surfaces of structure 12 to energy (e.g., light energy, electromagnetic radiation, vibrations, heat, a chemical catalyst or hardener, etc.) during the formation of structure 12. The energy may increase a rate of chemical reaction occurring within the matrix, sinter the material, harden the material, or otherwise cause the material to cure as it discharges from head 16.

A controller 22 may be provided and communicatively coupled with support 14, head 16, and any number and type of cure enhancers 20. Controller 22 may embody a single processor or multiple processors that include a means for controlling an operation of system 10. Controller 22 may include one or more general- or special-purpose processors or microprocessors. Controller 22 may further include or be associated with a memory for storing data such as, for example, design limits, performance characteristics, operational instructions, matrix characteristics, reinforcement characteristics, characteristics of structure 12, and corresponding parameters of each component of system 10. Various other known circuits may be associated with controller 22, including power supply circuitry, signal-conditioning circuitry, solenoid/motor driver circuitry, communication circuitry, and other appropriate circuitry. Moreover, controller 22 may be capable of communicating with other components of system 10 via wired and/or wireless transmission.

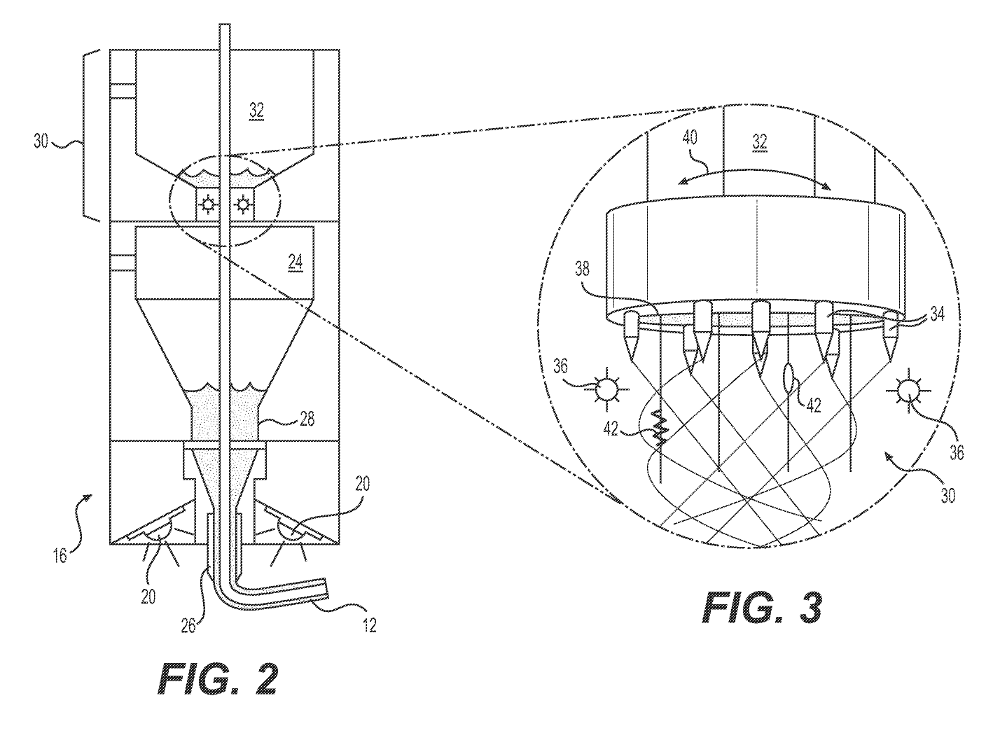

One or more maps may be stored in the memory of controller 22 and used during fabrication of structure 12. Each of these maps may include a collection of data in the form of models, lookup tables, graphs, and/or equations. In the disclosed embodiment, the maps are used by controller 22 to determine desired characteristics of cure enhancers 20, the associated matrix, and/or the associated reinforcements at different locations within structure 12. The characteristics may include, among others, a type, quantity, and/or configuration of reinforcement and/or matrix to be discharged at a particular location within structure 12, and/or an amount, intensity, shape, and/or location of desired curing. Controller 22 may then correlate operation of support 14 (e.g., the location and/or orientation of head 16) and/or the discharge of material from head 16 (a type of material, desired performance of the material, cross-linking requirements of the material, a discharge rate, etc.) with the operation of cure enhancers 20, such that structure 12 is produced in a desired manner. An exemplary head 16 is disclosed in detail in FIGS. 2 and 3. Head 16 may include, among other things, a matrix reservoir 24, and a nozzle 26 fluidly connected to matrix reservoir 24. In this example, nozzle 26 is single path nozzle configured to discharge composite material having a generally circular cross-section. The configuration of head 16, however, may allow nozzle 26 to be swapped out for another nozzle (not shown) that discharges composite material having a different shape (e.g., a tubular cross-section, a linear cross-section, a box-shaped cross-section, etc.).

An internal volume of matrix reservoir 24 may communicate with nozzle 26 via a central opening 28. In the disclosed embodiment, matrix reservoir 24 may have a generally circular cross-section, and taper radially inward to central opening 28. A size (e.g., diameter and/or height) of matrix reservoir 24 may be sufficient to hold a supply of matrix material necessary for wetting reinforcements passing through nozzle 26.

Head 16 may additionally include an in-situ fiber fabrication mechanism (FFM) 30 located upstream of matrix reservoir 24. FFM 30 may be configured to fabricate reinforcement(s) that replace or supplement the prefabricated reinforcements normally directed through matrix reservoir 24 and discharged from nozzle 26. By fabricating the reinforcements in-situ, a cost of fabrication may be reduced, while customization of the resulting composite structure 12 may be increased.

FFM 30 may be configured and function in a manner similar to the rest of head 16. For example, FFM 30 may itself include a matrix reservoir 32, one or more nozzles 34 that communicate with matrix reservoir 32, and one or more cure enhancers 36. It should be noted that the matrix material contained within reservoir 32 may be the same as or different from the matrix material contained within matrix reservoir 24, and that cure enhancers 36 may be the same as or different from cure enhancers 20 (e.g., cure enhancers 36 may generate a different type and/or wavelength of cure energy). In the example shown in of FIG. 3, multiple nozzles 34 are located in a ring around a central opening 38. It is contemplated, however, that any number of nozzles 34 may be used and arranged in any desired manner.

During operation, the material from matrix reservoir 32 may be directed through nozzle(s) 34, and nozzle(s) 34 may function to shape, size, and/or arrange the corresponding flow(s) of matrix material. As the matrix discharges from nozzles 34, the matrix may be exposed to cure energy from cure enhancers 36, causing the matrix to cure and harden into one or more separate continuous fiber strands. The strands may then be wetted in matrix reservoir 24, and thereafter discharged from nozzle 26 in the same manner that prefabricated reinforcements are wetted and discharged. As described above, during discharge from nozzle 26, the coating of matrix material received during passage of the fiber strands through matrix reservoir 24 may be exposed to cure energy generated by cure enhancers 20 (referring to FIG. 2).

In some embodiments, nozzles 34 may be selectively moved during discharge (e.g., relative to the rest of head 16), such that the fiber strands discharging therefrom are woven into a desired pattern. For example, one or more actuators 40 may be selectively energized to oscillate, rotate, shift side-to-side, and/or axially translate nozzle(s) 34, to thereby change a trajectory and/or spacing between the discharging fiber strands.

Central opening 38 may allow for combined use of pre-fabricated reinforcements and in-situ fabricated reinforcements. For example, one or more pre-fabricated continuous fiber strands may be directed axially through central opening 38, alone or at the same time that continuous fiber strands are being fabricated via nozzle(s) 34 and cure enhancers 36. This may allow for the prefabricated fiber strands to be interwoven with the in-situ fabricated fiber strands and/or for fiber strands of a first material, composition, size, shape, and/or trajectory to be interchanged and/or intermingled with fibers strands of a second material, composition, size, shape, and/or trajectory. For example, carbon fibers may extend axially through central opening 38 and be wrapped or otherwise interwoven (e.g., laced together) with external spiraling aramid fibers.

In some embodiments, the prefabricated fiber strands passing through central opening 38 may include functional elements 42. These functional elements 42 may include, for example, resisters, capacitors, light-emitting diodes (LED), RFID tags, switches, batteries, fuses, filters (e.g., low-pass filters), etc. Functional elements 42 may then pass through nozzle 26 along with the connected fiber strands and, thereby, become an integral portion of structure 12.

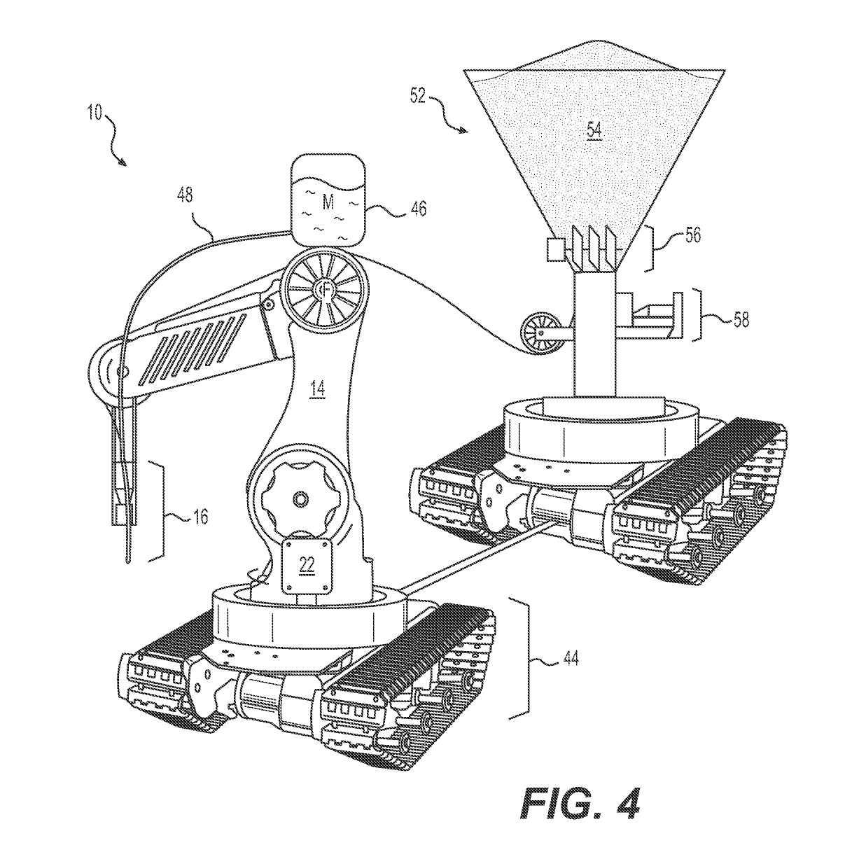

An application-specific arrangement of system 10 is illustrated in FIG. 4. In this arrangement, system 10 is mobile. For example, support 14 may be mounted on an undercarriage (e.g., crawler tracks, wheels, belts, etc.) 44, connected to rails in a factory floor, hung from ceiling beams, or otherwise carried in a mobile manner. When system 10 is used in this way, mobile supplies of liquid matrix M and reinforcement materials (e.g., fibers F) may be required.

As shown in FIG. 4, the liquid matrix M may be gravity-fed to head 16. In particular, an external supply 46 may be mounted to support 14 at a location that normally remains elevated above head 16. For example, external supply 46 may be mounted at an elbow location of a robotic arm. A flexible passage 48 may extend from supply 46 into head 16 in this configuration, such that the liquid matrix M continuously flows to head 16 during movement of support 14. In this same configuration, a spool 50 of fibers F may also be mounted at the elbow location (or elsewhere on the robotic arm of support 14).

In the embodiment of FIG. 4, like the embodiment of FIGS. 2 and 3, it may be more practical and/or efficient to make the fibers F in-situ, rather than to continuously supply head 16 with ready-made reinforcement materials. In the example of FIG. 4, a fiber-making apparatus (“apparatus”) 52 is towed behind system 10 for this purpose. Apparatus 52 may embody, for example, a mobile extruder or press having a hopper 54 for receiving raw materials (e.g., silicon), a heater 56 for liquefying the materials, and a die 58 through which molten material is pressed. The material, upon exiting die 58, hardens and can be fed onto spool 50 mounted on support 14 or directly into head 16. It is contemplated that die 58 may have any shape, size, and/or configuration, and/or that die 58 may be modular and swappable with other dies having different shapes, sizes, and/or configurations.

### INDUSTRIAL APPLICABILITY

The disclosed system may be used to continuously manufacture composite structures having any desired cross-sectional size, shape, length, density, strength and/or surface texture. The composite structures may include any number of different reinforcements of the same or different types, diameters, shapes, configurations, and consists, each coated with a common matrix and/or resin. Operation of system 10 will now be described in detail.

At a start of a manufacturing event, information regarding a desired structure 12 may be loaded into system 10 (e.g., into controller 22 that is responsible for regulating operations of system 10). This information may include, among other things, a size (e.g., diameter, wall thickness, length, etc.), a contour (e.g., a trajectory), surface features (e.g., ridge size, location, thickness, length; flange size, location, thickness, length; etc.) and finishes, connection geometry (e.g., locations and sizes of couplings, tees, splices, etc.), location-specific matrix stipulations, location-specific reinforcement stipulations, etc. It should be noted that this information may alternatively or additionally be loaded into system 10 at different times and/or continuously during the manufacturing event, if desired. Based on the component information, the base constituents of one or more different to-be-fabricated reinforcements may be selectively supplied to reservoir 32 and/or hopper 54. At this same time and based on the same information, a matrix may be supplied to reservoir 24, and one or more pre-fabricated reinforcements may be threaded through FFM 30, reservoir 24, and nozzle 26.

FFM 30 and/or apparatus 52 may then be activated to fabricate (and, in some embodiments, to weave together) reinforcements that subsequently are directed through reservoir 24 and nozzle 26, alone or in addition to the pre-fabricated reinforcements. For example, the matrix material from reservoir 32 may be directed through nozzle(s) 34, where the matrix material is discharged as separate strands. Upon discharge, the separate strands may be exposed to cure energy from cure enhancers 36, causing the material to harden. These hardened strands may then be woven together (and, in some embodiments, with pre-fabricated fiber strands), and passed alone through nozzle 26 or passed along with other reinforcements received via central opening 38 of FFM 30. The other reinforcements may be as-purchased prefabricated reinforcements or reinforcements fabricated by apparatus 52. For example, raw materials from hopper 54 may be extruded through die 58, hardened (e.g., via cooling), and then passed through FFM 30 as the pre-fabricated reinforcements. The reinforcements (i.e., the prefabricated and/or in-situ fabricated reinforcements) may be wetted within reservoir 24, and thereafter discharged through nozzle 26.

Head 16 may be moved by support 14 under the regulation of controller 22 to cause matrix-coated reinforcements to be placed against or on a corresponding anchor point 18. Cure enhancers 20 within head 16 may be selectively activated to cause hardening of the matrix surrounding the reinforcements, thereby bonding the reinforcements to anchor point 18.

The component information may then be used to control operation of system 10. For example, the reinforcements may be pulled and/or pushed from head 16 (along with the matrix), while support 14 selectively moves head 16 in a desired manner during exposure of the matrix-coated reinforcement to cure energy, such that an axis of the resulting structure 12 follows a desired trajectory.

It will be apparent to those skilled in the art that various modifications and variations can be made to the disclosed additive manufacturing system. Other embodiments will be apparent to those skilled in the art from consideration of the specification and practice of the disclosed additive manufacturing system. It is intended that the specification and examples be considered as exemplary only, with a true scope being indicated by the following claims and their equivalents.

What is claimed is:

1. An additive manufacturing system, comprising:
a support moveable in multiple dimensions;
a print head connected to an end of the support and including:
a first matrix reservoir configured to wet a continuous strand reinforcement;
a first nozzle fluidly connected to the first matrix reservoir; and
a first cure enhancer located to expose the continuous strand reinforcement to cure energy upon discharge from the first nozzle; and
an in-situ fiber-making apparatus configured to supply the continuous strand reinforcement to the first matrix reservoir of the print head.

2. The additive manufacturing system of claim 1, wherein the in-situ fiber-making apparatus includes:
a second matrix reservoir;
at least a second nozzle fluidly connected to the second matrix reservoir; and
a second cure enhancer located to cure matrix material discharging from the at least a second nozzle into continuous strand reinforcement.

3. The additive manufacturing system of claim 2, wherein the in-situ fiber-making apparatus is mechanically and fluidly connected to the print head.

4. The additive manufacturing system of claim 2, wherein the at least a second nozzle includes a plurality of nozzles configured to discharge a plurality of continuous strand reinforcements.

5. The additive manufacturing system of claim 4, wherein the plurality of nozzles is arranged in a circle around a central opening.

6. The additive manufacturing system of claim 5, further including a supply configured to direct a pre-fabricated continuous strand reinforcement through the central opening.

7. The additive manufacturing system of claim 6, wherein the pre-fabricated continuous strand reinforcement includes at least one of a resister, a capacitor, a light-emitting diode, an RFID tag, a switch, a battery, a fuse, and a filter integrated between connected fiber strands.

8. The additive manufacturing system of claim 4, further including at least one actuator configured to move the plurality of nozzles and weave the plurality of continuous strand reinforcements.

9. The additive manufacturing system of claim 1, wherein the in-situ fiber-making apparatus includes:
a hopper;
a die through which material from the hopper is pressed to form the continuous strand reinforcement; and
a heater configured to liquefy the material from the hopper.

10. The additive manufacturing system of claim 1, further including:
a hopper; and
a die through which material from the hopper is pressed to form a pre-fabricated continuous strand material that is directed through the print head along with the continuous strand reinforcement from the in-situ fiber-making apparatus.

11. The additive manufacturing system of claim 1, further including a first mobile undercarriage on which the support is mounted.

12. The additive manufacturing system of claim 11, further including a second mobile undercarriage towed by the first mobile undercarriage and configured to support the in-situ fiber-making apparatus.

13. A method of additively manufacturing a composite structure, comprising:
fabricating a continuous strand reinforcement;
wetting the continuous strand reinforcement with a matrix, as the continuous strand reinforcement is fabricated;
discharging the matrix-wetted continuous strand reinforcement through a nozzle; and
exposing the matrix wetting the continuous strand reinforcement to cure energy upon discharge from the nozzle; and
moving the nozzle in multiple dimensions during discharge.

14. The method of claim 13, wherein fabricating the continuous strand reinforcement includes:
directing a second matrix through at least a second nozzle to form the continuous strand reinforcement; and
hardening the continuous strand reinforcement before wetting the continuous strand reinforcement.

15. The method of claim 14, wherein directing the second matrix through the at least a second nozzle includes directing the second matrix through a plurality of nozzles to form a plurality of continuous strand reinforcements.

16. The method of claim 15, further including directing a pre-fabricated continuous strand reinforcement through a central opening between the plurality of nozzles.

17. The method of claim 15, further including weaving the plurality of continuous strand reinforcements.

18. The method of claim 13, wherein fabricating the continuous strand reinforcement includes pressing raw material from a hopper through a die.

19. The method of claim 18, further including liquefying the raw material from the hopper prior to pressing the raw material through the die.

20. The method of claim 13, wherein:
moving the nozzle in multiple dimensions during discharge includes moving a print head housing the nozzle with a support; and
the method further includes:
mobilizing the support; and
at least one of carrying on the support and towing behind the support an apparatus fabricating the continuous strand reinforcement.
